(19) United States
(12) Patent Application Publication
(10) Pub. No.: US 2024/0345297 A1
(43) Pub. Date: Oct. 17, 2024

(54) DEVICE FOR A VEHICLE, COMPRISING A CAMERA AND A MASKING ZONE OPPOSITE SAID CAMERA

(71) Applicant: VALEO VISION, Bobigny (FR)

(72) Inventors: Thomas DUFILS, Bobigny Cedex (FR); Christophe GRARD, Bobigny Cedex (FR); Gregory PLANCHE, Bobigny Cedex (FR); Pierre RENAUD, Bobigny Cedex (FR); Kostadin BEEV, Bobigny Cedex (FR)

(73) Assignee: VALEO VISION, Bobigny (FR)

(21) Appl. No.: 18/683,137

(22) PCT Filed: Aug. 4, 2022
(86) PCT No.: PCT/EP2022/072027

§ 371 Date: Feb. 12, 2024

(30) Foreign Application Priority Data
Sep. 3, 2021 (FR) FR2109257

(51) Int. Cl. G02B 5/08; B60R 1/24

(52) U.S. Cl. CPC G02B 5/085; B60R 1/24; G02B 2207/123

(57) ABSTRACT

A device for a vehicle is configured to perform at least one observation function (F). The device includes at least one camera, an output lens and a sub-array including the at least one camera. The device includes a masking zone covering a surface of the device, the masking zone being arranged opposite the camera and configured to reduce the transmission of light (Lx) entering the device by the surface.

The present invention relates to a device for a vehicle, said device being configured to perform an observation function. The present invention is particularly, but nonlimitingly, applicable to smart electric motor vehicles.

Smart electric vehicles require observation functions to carry out autonomous or semi-autonomous driving. Consequently, these vehicles incorporate one or more devices enabling such observation functions to be carried out.

One example known to the person skilled in the art of a device for a vehicle configured to carry out at least one observation function comprises:
a camera, and
an exit outer lens, and
a subassembly comprising said camera.

The camera enables observation of the environment outside the vehicle, and notably the detection of moving or stationary objects around the vehicle.

In terms of style, manufacturers often require black opaque front or rear panels (called black panels) and for the device to be integrated into these panels so that elements inside the device, notably the camera, cannot be seen.

One drawback of this prior art is that such black opaque front or rear panels adversely affect the observation function or functions carried out by the device.

In this context, the present invention aims to provide a device that makes it possible to overcome the stated drawback.

For this purpose, the invention proposes a device for a vehicle, said device being configured to perform an observation function and comprising a camera, an exit outer lens and a subassembly comprising said camera, characterized in that said device comprises a masking zone covering a surface of said device, said masking zone being positioned facing said camera and configured to reduce the transmission of light entering said device through said surface.

Thus, as detailed below, the device makes it possible to overcome these limitations by concealing the elements inside the vehicle, notably the camera, without significantly impacting the observation function of said device.

According to nonlimiting embodiments, said device may furthermore comprise one or more of the following additional features, implemented alone or in any technically possible combination.

According to one nonlimiting embodiment, said surface is covered in whole or in part by said masking zone.

According to one nonlimiting embodiment, said surface belongs to said exit outer lens.

According to one nonlimiting embodiment, said exit outer lens belongs to a style part of said device.

According to one nonlimiting embodiment, said surface belongs to an intermediate element of said device positioned between said camera and said exit outer lens.

According to one nonlimiting embodiment, said masking zone is a textured film comprising features.

According to one nonlimiting embodiment, said features are surface features or bulk features.

According to one nonlimiting embodiment, said surface features are produced using an IML or IMD process.

According to one nonlimiting embodiment, where said features are surface features, they are formed by an ink deposit between 1 and 10 microns thick.

According to one nonlimiting embodiment, said features are occulting or semi-transparent.

According to one nonlimiting embodiment, said features are continuous lines or punctiform features.

According to one nonlimiting embodiment, there is a pitch between said features and said pitch has a maximum value of 0.8 mm between the center of two features.

According to one nonlimiting embodiment, said surface comprising said textured film is configured to transmit light variably.

According to one nonlimiting embodiment, said features are arranged so that there is a variable pitch between said features and/or so that the features have a variable material density and/or so that there is a variable area between the features.

According to one nonlimiting embodiment, said features form a negative image of punctiform features, said punctiform features being substantially transparent.

According to one nonlimiting embodiment, said surface comprising said textured film is configured to transmit light variably.

According to one nonlimiting embodiment, said punctiform features are arranged so that there is a variable pitch between said punctiform features and/or so that the punctiform features have a variable area.

According to one nonlimiting embodiment, the negative image comprises different areas with different material densities.

According to one nonlimiting embodiment, said masking zone is a cold mirror.

According to one nonlimiting embodiment, said masking zone comprises a plurality of layers with alternating high and low refractive indices.

According to one nonlimiting embodiment, said masking zone comprises a single metal layer having a thickness in the order of nanometers.

According to one nonlimiting embodiment, said metal layer is a chromium, aluminum, germanium, or silicon layer.

According to one nonlimiting embodiment, said device further comprises a mask.

According to one nonlimiting embodiment, said style part is a logo.

According to one nonlimiting embodiment, said logo is an illuminated logo.

The invention and the different applications thereof can be better understood from the description below and the accompanying figures:

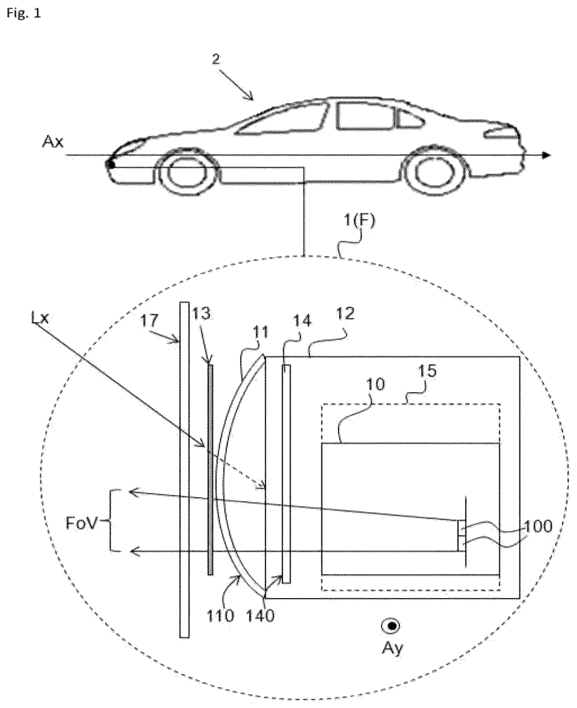

FIG. 1 is a schematic profile view of a device for a vehicle, said device comprising a camera, a subassembly, an exit outer lens, a masking zone, and a style part, according to one nonlimiting embodiment of the invention,

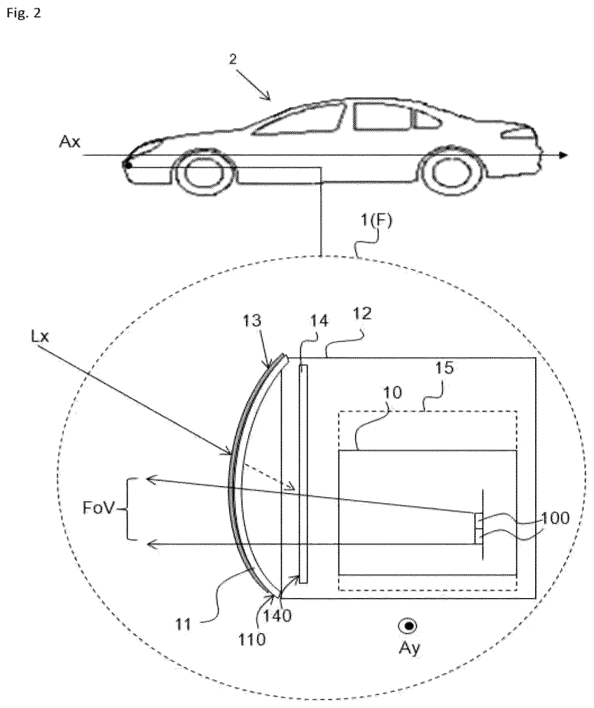

FIG. 2 is a schematic profile view of said device of FIG. 1 without the style part, said masking zone being positioned on a surface of said device that belongs to said exit outer lens, according to a first nonlimiting embodiment,

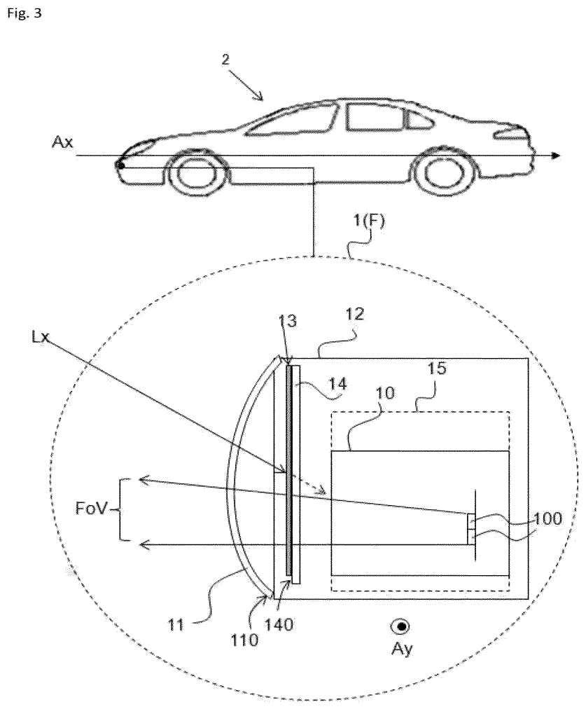

FIG. 3 is a schematic profile view of said device of FIG. 1 without the style part, said masking zone being positioned on a surface of said device that belongs to an intermediate element between said exit outer lens and said camera, according to a second nonlimiting embodiment,

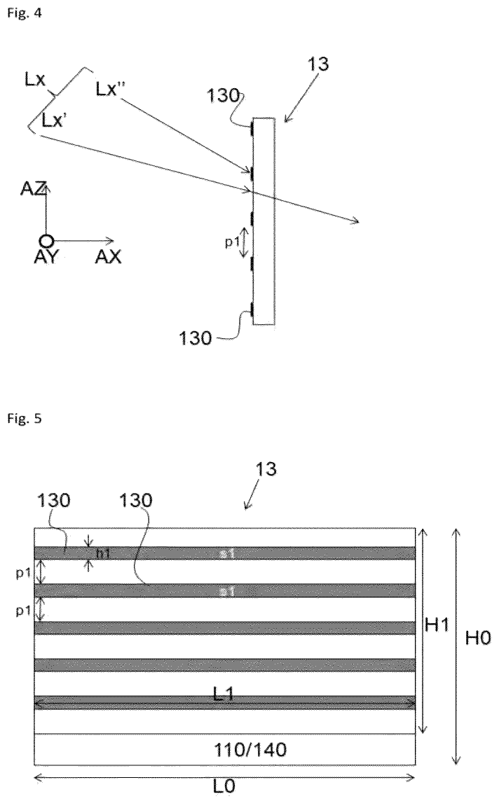

FIG. 4 is a schematic profile view of the masking zone covering the surface of said device of FIG. 1, said masking zone being a film textured with surface features according to a first variant of a first nonlimiting embodiment,

FIG. 5 is a schematic front view of said masking zone of FIG. 4,

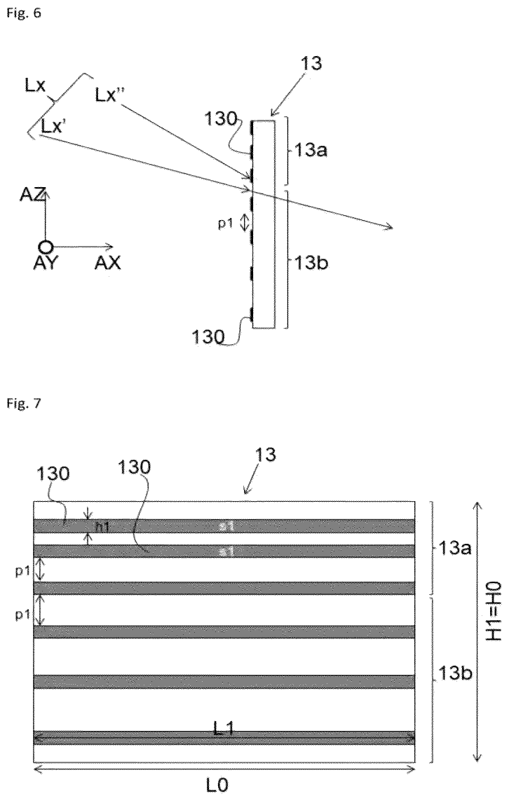

FIG. 6 is a schematic profile view of the masking zone covering the surface of said device of FIG. 1, said masking zone being a film textured with surface features according to a second variant of a first nonlimiting embodiment,

FIG. 7 is a schematic front view of said masking zone of FIG. 6,

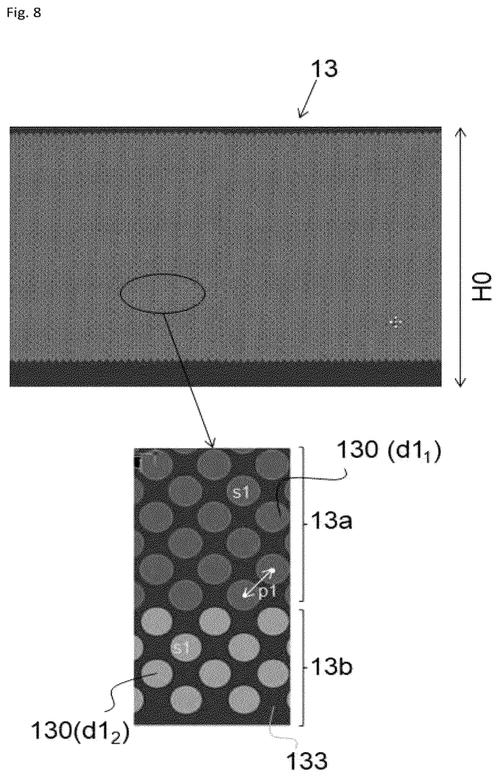

FIG. 8 is a schematic front view of the masking zone covering the surface of said device of FIG. 1, said masking zone being a film textured with surface features according to a third variant of a first nonlimiting embodiment,

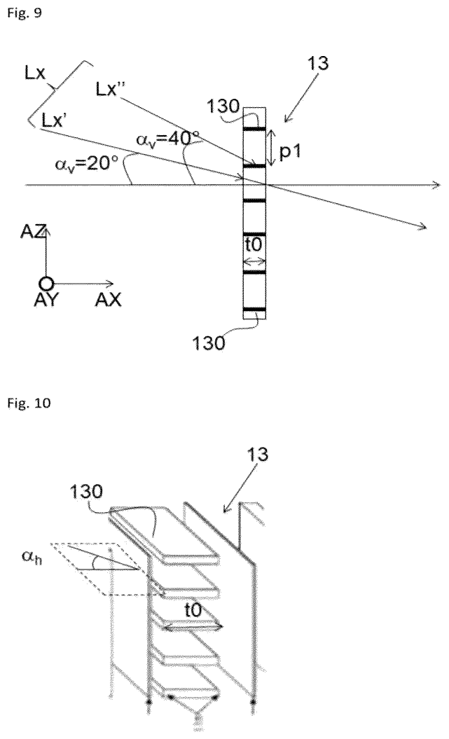

FIG. 9 is a schematic profile view of the masking zone covering the surface of said device of FIG. 1, said masking zone being a film textured with bulk features, according to a first variant of a second nonlimiting embodiment,

FIG. 10 is a schematic perspective view of said masking zone of FIG. 9,

FIG. 11 is a schematic profile view of the masking zone covering the surface of said device of FIG. 1, said masking zone being a film textured with bulk features, according to a second variant of a second nonlimiting embodiment,

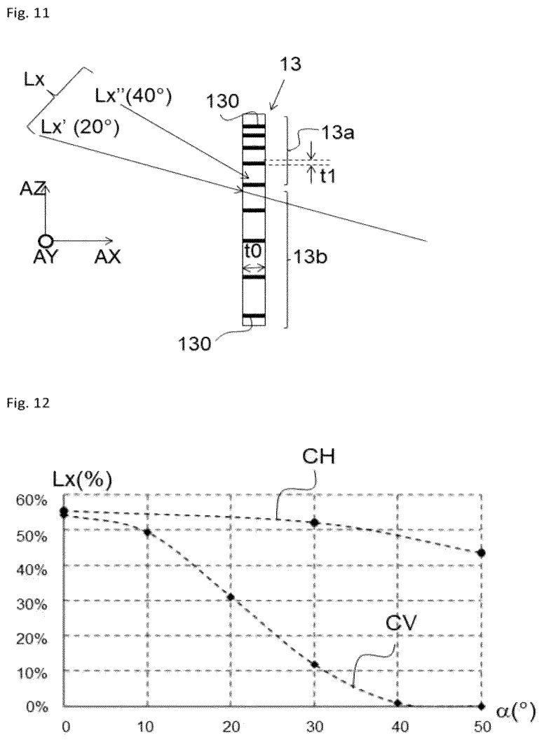

FIG. 12 is a graph illustrating a difference in the transmittance of the surface as a function of a vertical angle of incidence and of a horizontal angle of incidence of light incident on the surface of FIG. 9 or FIG. 11, according to one nonlimiting embodiment,

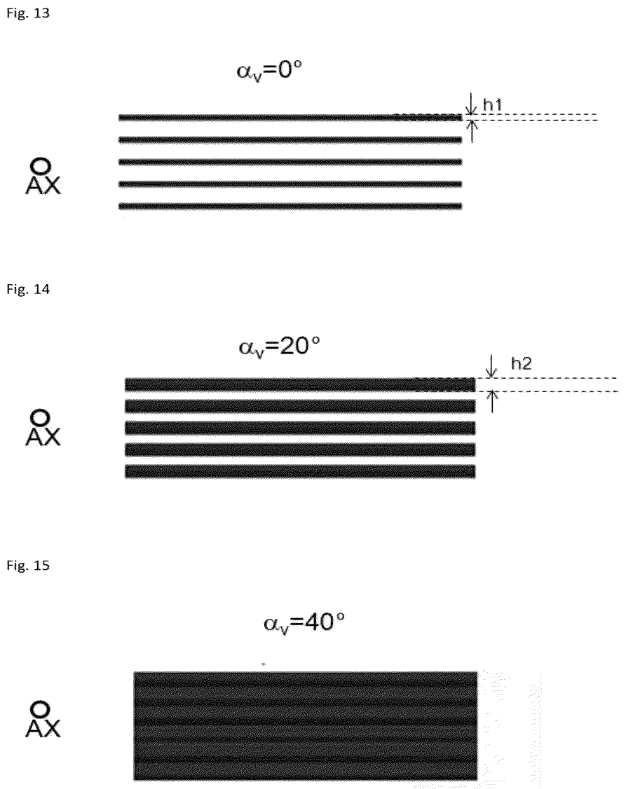

FIG. 13 is a schematic view of a masking zone that is a film textured with bulk features along a vehicle axis, with a vertical angle of incidence of the light incident on the surface of FIG. 9 or FIG. 11 of zero,

FIG. 14 is a schematic view of a masking zone that is a film textured with bulk features along a vehicle axis, with a vertical angle of incidence of the light incident on the surface of FIG. 9 or FIG. 11 of 20°,

FIG. 15 is a schematic view of a masking zone that is a film textured with bulk features along a vehicle axis, with a vertical angle of incidence of the light incident on the surface of FIG. 9 or FIG. 11 of 40°,

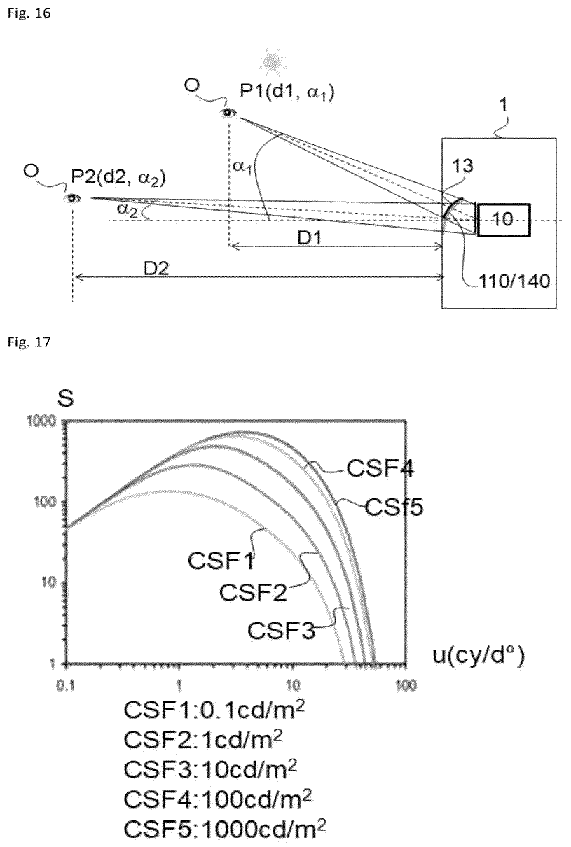

FIG. 16 is a schematic view of said device according to any one of FIGS. 1 to 11, 18 to 21 observed by an observer outside the vehicle, at two different observation angles, according to one nonlimiting embodiment,

FIG. 17 is a graph of curves of the contrast sensitivity of an eye of an observer observing said device according to one of FIGS. 1 to 11, 18 to 21 from outside the vehicle,

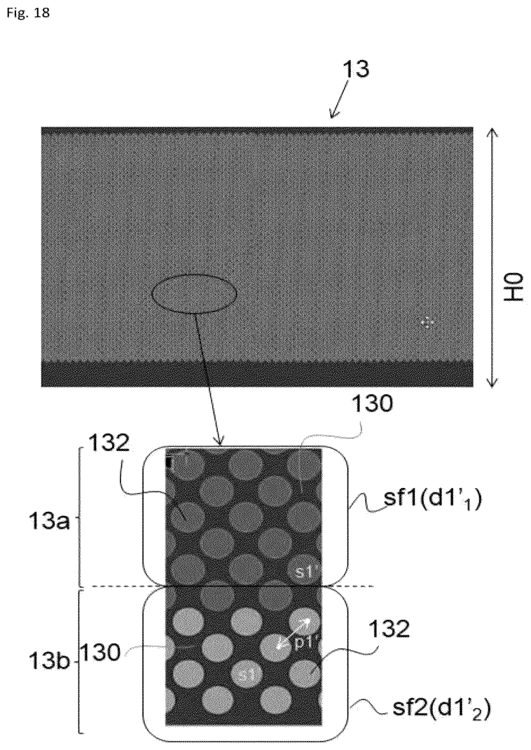

FIG. 18 is a schematic front view of the masking zone covering the surface of said device of FIG. 1, said masking zone being a film textured with surface features according to a fourth variant of a first nonlimiting embodiment,

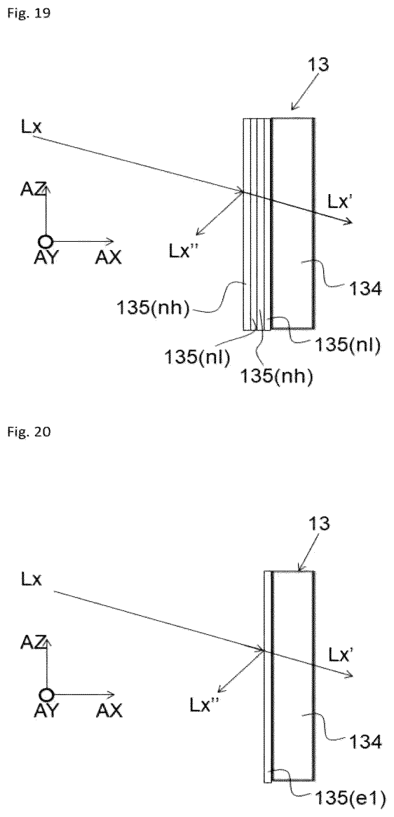

FIG. 19 is a schematic profile view of the masking zone covering the surface of said device of FIG. 1, said masking zone being a cold mirror according to a third nonlimiting embodiment,

FIG. 20 is a schematic profile view of the masking zone covering the surface of said device of FIG. 1, said masking zone comprising a single metal layer according to a fourth nonlimiting embodiment,

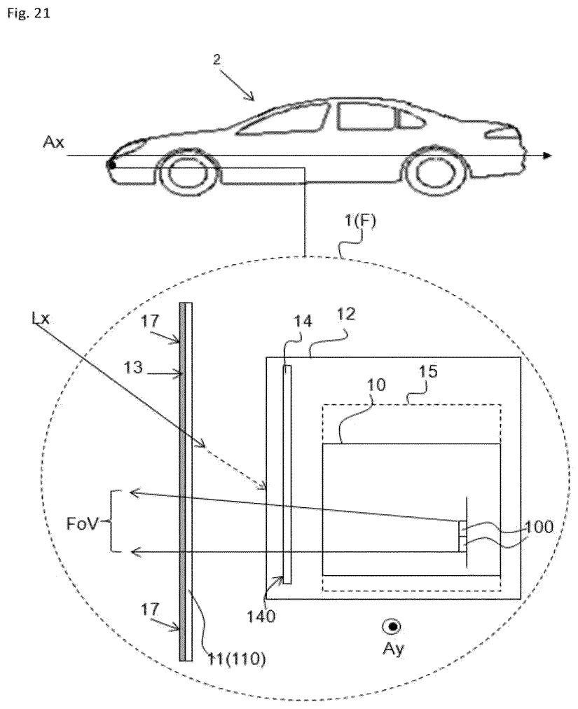

FIG. 21 is a schematic profile view of said device of FIG. 1, said exit outer lens of FIG. 2 belonging to said style part, according to a first variant of a nonlimiting embodiment,

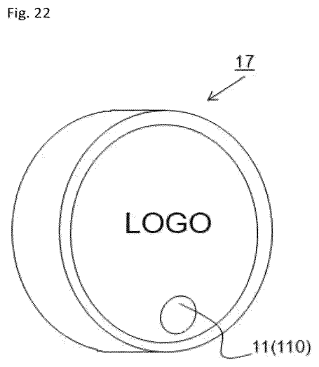

FIG. 22 is a perspective view of said style part of the device of FIG. 1, said exit outer lens of FIG. 2 belonging to said style part, according to a second variant of a nonlimiting embodiment.

Elements that are identical in terms of structure or function and that appear in various figures are designated by the same references, unless indicated otherwise.

The device 1 according to the invention for a vehicle 2 is described with reference to FIGS. 1 to 22. In one nonlimiting embodiment, the vehicle 2 is a motor vehicle. “Motor vehicle” means any type of motorized vehicle. This embodiment will be considered, by way of nonlimiting example, in the remainder of the description. In the remainder of the description, the vehicle 2 is thus also referred to as the motor vehicle 2. In one nonlimiting variant of embodiment, the vehicle 2 is a semi-autonomous or autonomous electric vehicle.

The device 1 is configured to carry out at least one observation function F. The observation function F makes it possible to detect moving objects (other vehicles, pedestrians, cyclists, etc.) or stationary objects (trees, buildings, street furniture, road markings, etc.) in the environment outside the motor vehicle 2. This observation function F enables functions related to semi-autonomous or autonomous driving to be carried out, nonlimiting examples of which include automatic braking, automatic steering or acceleration control, autonomous highway driving, etc.

In nonlimiting embodiments, the device 1 can be built into the front, the rear or the sides of the motor vehicle 2. Thus, in nonlimiting examples, the device 1 is built into the front face or the rear face of the motor vehicle 2.

As illustrated in FIG. 1, the device 1 for a vehicle 2 comprises:
a camera 10, and
an exit outer lens 11, and
a subassembly 12 comprising said camera 10, and
a masking zone 13 configured to conceal said camera 10.

In one nonlimiting embodiment, the device 1 further comprises an intermediate element 14 positioned between the camera 10 and the exit outer lens 11.

In one nonlimiting example, the device 1 further comprises a style part 17 (illustrated in FIG. 1). In one nonlimiting embodiment, the style part 17 is a logo. The logo 17 may be illuminated or otherwise. Where illuminated, the logo comprises one or more light sources (not shown).

In nonlimiting embodiments, the subassembly 12 is a housing or a front grille or a rear grille. The camera 10 is thus built into a housing or into a front grille or a rear grille. In the remainder of the description, the housing is taken as a nonlimiting example. It is therefore referred to as the housing 12.

In the nonlimiting example illustrated, the device 1 comprises a single camera 10. In one nonlimiting embodiment, the device 1 further comprises a mask 15. The mask 15 surrounds the camera 10. This is illustrated in dotted lines in FIG. 1 because it extends along an axis Ay perpendicular to the vehicle axis Ax. The mask 15 that surrounds the camera 10 is a decorative mask. It is also called a bezel.

In nonlimiting embodiment, the camera 10 is an infrared (IR) or near-infrared (NIR) camera or a camera that operates in the visible spectrum. The camera 10 has a field of vision FoV (shown in FIGS. 1 to 3).

In one nonlimiting embodiment, the camera 10 comprises a plurality of optical sensors 100. This nonlimiting embodiment will be considered, by way of nonlimiting example, in the remainder of the description. Two optical sensors 100 are shown in FIG. 1.

The optical sensors 100 are photosensitive electronic components that are configured to convert electromagnetic radiation from light (visible or IR or NIR) into an analog electric signal. This signal is then amplified and digitized by an analog-digital converter (not shown) and finally processed to obtain a digital image. The optical sensors 100 receive light Lx from outside the motor vehicle 2. The light Lx is also referred to as ambient light Lx.

As illustrated in FIG. 1, the masking zone 13 is positioned facing the camera 10. It covers one surface 110, 140 of the device 1. It will be noted that FIG. 1 is an exploded view of the device 1. Thus, the masking zone 13 is shown at a distance from the two surfaces 110, 140. The surface 110, 140 is covered in whole or in part by said masking zone 13. In the nonlimiting example illustrated in FIG. 5, the surface 110, 140 is partially covered, whereas in the nonlimiting example illustrated in FIG. 7, the surface 110, 140 is completely covered. The surface covered by the masking zone 13 is defined by different nonlimiting embodiments. For this reason it is denoted using different reference numbers, specifically 110, 140, relating to the different nonlimiting embodiments.

In a first nonlimiting embodiment illustrated in FIG. 2, the surface 110 covered by the masking zone 13 belongs to the exit outer lens 11. In a nonlimiting variant embodiment, said surface 110 is the inner face or the outer face of the exit outer lens 11. The exit outer lens 11 has a curved surface 110. In a nonlimiting variant embodiment illustrated in FIG. 21 and FIG. 22, said exit outer lens 11 comprising said surface 110 belongs to said style part 17. In a first nonlimiting embodiment illustrated in FIG. 21 of this nonlimiting variant embodiment, the style part 17 is partially transparent. In this case, the surface 110 covered by the masking zone 13 may extend over the whole of the style part 17, as shown in FIG. 21. In a nonlimiting example embodiment, said surface 110 is one of the faces of the style part 17. The face may be the face facing the camera 10 or the face facing the outside of the motor vehicle 2. In a second nonlimiting embodiment illustrated in FIG. 22 of this nonlimiting variant embodiment, the style part 17 is made partially of a non-transparent material. In this case, the surface 110 covered by the masking zone 13 represents a very limited zone of the style part 17, as shown in FIG. 22.

In a second nonlimiting embodiment illustrated in FIG. 3, the surface 140 that is covered by the masking zone 13 belongs to the intermediate element 14 positioned between said camera 10 and the exit outer lens 11. In one nonlimiting variant embodiment, said surface 140 is one of the faces of said intermediate element 14. The face may be the face facing the exit outer lens 11 or the face facing said camera 10. This intermediate element 14 comprises a planar surface 140. This is intended to facilitate application of a textured film to a curved surface where the masking zone 13 is a textured film (described below). This is advantageous where the texture is a bulk texture, i.e. a textured film 13 with bulk features 130 (as described below). This facilitates application with respect to a curved surface, which may deform the bulk features 130, especially if its curvature is great.

In first and second nonlimiting embodiments illustrated in FIGS. 4 to 11 and 18, the masking zone 13 is a textured film comprising features 130. In the first nonlimiting embodiment, the features 130 are surface features. In the second nonlimiting embodiment, the features 130 are bulk features. These two embodiments are described below.

Where the exit outer lens 11 or the intermediate element 14 are only covered in part by the textured film 13, one portion of the surface 110, 140 thereof is thus devoid of features 130.

The textured film 13 comprises features 130 configured to reduce the transmission of light Lx entering said device 1 so as to conceal the elements inside the device 1, notably the camera 10, without degrading the observation function F of the device 1. This light Lx is ambient light originating from outside the motor vehicle 2. The features 130 are occulting or semi-transparent with a variable level of transparency.

“Occulting” means that the features 130 allow only between 0% and 20% of the light Lx to pass. “Semi-transparent” means that the features 130 allow only between 20% and 90% of the light Lx to pass.

In nonlimiting embodiments, said features 130 are continuous lines (as illustrated in FIGS. 4 to 7 and 9 to 11), also called texture lines, or punctiform features (as illustrated in FIG. 8). In another nonlimiting embodiment, said features 130 form a negative image of punctiform features 132 (as illustrated in FIG. 18). In the latter case, the negative image is otherwise referred to as the negative image 130.

When the light Lx strikes the surface 110 or 140 covered with the textured film 13, a part Lx′ will pass through said surface 110 or 140 while a part Lx″ will be wholly or partially stopped by one or more features 130 of the textured film 13, as illustrated in FIGS. 4, 6, 9 and 11. The features 130 help to reduce the transmission of light Lx entering the device 1, notably to conceal the camera 10 of the device 1 from outside the motor vehicle 2 while enabling the device 1 to continue effectively observing the environment outside the motor vehicle 2.

In a first nonlimiting embodiment illustrated in FIGS. 4 to 8 and 18, the features 130 are surface features. These are either continuous lines (defined by an area s1), or punctiform features (defined by an area s1), or a negative image of punctiform features 132.

Where the surface features 130 are continuous lines as illustrated in FIGS. 4 to 7, in one nonlimiting embodiment, the features 130 extend along the length L0 of the surface 110, 140. They are thus defined by a length L1 smaller than or equal to the length L0 of the surface 110, 140 and by a height h1. In the nonlimiting examples of FIGS. 5 and 7, L1=L0. Considered as a whole, the textured surface composed of the surface features 130 may have a height H1 less than or equal to the height H0 of the surface 110, 140. In the nonlimiting example of FIG. 5, H1<H0. In the nonlimiting example of FIG. 7, H1=H0.

The continuous lines 130 may have equal or different areas s1. Thus, they may have the same height h1 or different heights h1 and/or equal or different lengths L1. In one illustrated nonlimiting embodiment, the features 130 have the same length L1. In one nonlimiting mode, the height h1 of a continuous line is between 0.2 mm and 0.5 mm.

When the surface features 130 are punctiform features as illustrated in FIG. 8, in one nonlimiting example, they are dots that are defined by their area s1. The punctiform features 130 may have equal or different areas s1. In one nonlimiting embodiment, the area s1 is between 0.25 mm² and 0.75 mm². In one nonlimiting example, the material density of the punctiform features 130 is 50% with respect to the total area of the textured film 13. In another nonlimiting example, the material density is 42%. The textured film 13 is formed of punctiform features 130 and of a negative image 133 of the punctiform features 130. The punctiform features 130 are opaque or semi-transparent and reduce the transmission of the light Lx, while the negative image 133 is substantially transparent. It thus lets the light Lx pass through. The negative image 133 represents the remainder of the effective area of the textured film 130.

When the surface features 130 are a negative image of punctiform features 132 as illustrated in FIG. 18, the negative image 130 of said punctiform features 132 represents the remainder of the effective area of the textured film 13. The negative image 130 is opaque or semi-transparent and reduces the transmission of the light Lx while the punctiform features 132 for their part are substantially transparent. They thus let the light Lx pass through.

As illustrated in FIGS. 5, 7 and 8, the features 130 are spaced apart by a pitch p1. The pitch p1 may be constant or variable. In the case of FIG. 8, the pitch p1 is the distance between the center of the features 130. In a nonlimiting example, the pitch p1=0.424 mm with a distance of 0.12 mm between the punctiform features 130 and a radius of 0.152 mm in the case of punctiform features 130 that are dots. As illustrated in FIG. 18, the punctiform features 132 are spaced apart by a pitch p1′. The pitch p1′ may be constant or variable. In the case of FIG. 18, the pitch p1′ is the distance between the center of the punctiform features 132. In a nonlimiting example, the pitch p1′=0.424 mm with a distance of 0.12 mm between the punctiform features 132 and a radius of 0.152 mm in the case of punctiform features 132 that are dots.

In a first nonlimiting variant embodiment illustrated in FIGS. 4, 5, 8 and 18, the surface 110, 140 transmits the light Lx constantly (as opposed to having a transmittance that varies as a function of height of the surface 110, 140) considering the surface 110, 140 in its entirety. In this case, in the example of FIGS. 4, 5 and 8, the pitch p1 between the features 130 remains constant, and the material density d1 of the features 130 remains constant, and the area s1 between the features 130 remains constant. Thus d1₁=d1₂ in the nonlimiting example illustrated in FIG. 8.

In this case, in the example of FIG. 18, the pitch p1′ between the punctiform features 132 remains constant, and the area s1′ between the punctiform features 132 remains constant, and the material density d1′ of the negative image 130 remains constant in all the areas sf making up said negative image 130. Thus d1₁=d1₂ in the nonlimiting example illustrated in FIG. 18. In a nonlimiting example, the material density d1′₁=d1′₂=50%. In another nonlimiting example, the material density is 42%.

In a second nonlimiting variant embodiment, the surface 110, 140 transmits the light Lx variably in the direction of its height H0. The top portion 13a of the textured film 13 will be more occulting than the bottom portion 13b. Transmittance is higher in front of the camera 10 to enable detection of moving or stationary objects in the environment outside the motor vehicle 2 to ensure that the observation function F is not degraded, and transmittance is reduced gradually with the height H0 of the surface 110, 140. The greater the height, the lower the transmittance.

Where the features 130 are continuous lines or punctiform features, in one nonlimiting embodiment, the surface 110, 140 transmits the light Lx variably as a result of arranging said features 130 so that the features 130 have a variable material density d1 and/or so that there is a variable pitch p1 between the features 130 and/or so that the features 130 have a variable area s1.

Where the features 130 are a negative image of punctiform features 132, in another nonlimiting embodiment, the surface 110, 140 transmits the light Lx variably as a result of arranging said punctiform features 132 so that the punctiform features 132 have a variable pitch p1′ and/or so that there is a variable area s1′ between the punctiform features 132, or as a result of arranging various areas sf of said negative image 130 to have different material densities d1′.

Thus, to make the features 130 relatively dense in the material thereof, in one nonlimiting embodiment, the thickness or density of an ink deposit that is used to produce said features 130 may be varied. It will be noted that where the material density d1 of the features 130 (punctiform features 130 or continuous lines 130) or the material density d1′ of various areas sf of the negative image 130 is varied, the transmission of light varies. Certain features 130 (punctiform features 130 or continuous lines 130) or one or more areas sf of the negative image 130 may be completely occulting, while others may be semi-transparent. In the nonlimiting example illustrated in FIG. 8, for example, some features 130 thus have a material density d1₁ denser than other features of material density d1₂. In the nonlimiting example illustrated in FIG. 18, for example, the area sf1 thus has a material density d1′₁ denser than the area sf2 of material density d1′₂. The denser the material density d1 or d1′, the lower the transmission of the light Lx will be. Thus, in a nonlimiting example embodiment, the features 130 (punctiform features 130 or continuous lines 130) or the areas sf of the negative image 130 located in the top portion 13a of the textured film 13 (and therefore toward the top of the surface 110, 140) will have a material density d1 or d1′ that is higher, so as to make the top portion 13a more occulting, than that of the features 130 (punctiform features 130 or continuous lines 130) or areas sf of the negative image 130 located in the bottom portion 13b of the textured film 13 (and therefore toward the bottom of the surface 110, 140), so as to make the bottom portion 13b less occulting.

Thus, in one nonlimiting embodiment, the features 130 are arranged so that groups of features 130 have variable areas s1, a group of features 130 comprising one or more features 130. Thus, in a nonlimiting example embodiment, the features 130 located in the top portion 13a of the textured film 13 (and therefore toward the top of the surface 110, 140) will have an area s1 that is larger, so as to make the top portion 13a more occulting, than that of the features 130 located in the bottom portion 13b of the textured film 13 (and therefore toward the bottom of the surface 110, 140), so as to make the bottom portion 13b less occulting.

Thus, in one nonlimiting embodiment, the punctiform features 132 are arranged so that groups of punctiform features 132 have variable areas s1′, a group of punctiform features 132 comprising one or more punctiform features 132. Thus, in a nonlimiting example embodiment, the punctiform features 132 located in the top portion 13a of the textured film 13 (and therefore toward the top of the surface 110, 140) will have an area s1′ that is smaller, so as to make the top portion 13a more occulting, than that of the punctiform features 132 located in the bottom portion 13b of the textured film 13 (and therefore toward the bottom of the surface 110, 140), so as to make the bottom portion 13b less occulting.

Thus, in one nonlimiting embodiment, the features 130 are arranged so that there is a variable pitch p1 therebetween. In one nonlimiting example, the pitch p1 varies from 0.5 mm to 5 mm. In one nonlimiting example, the pitch p1 has a maximum value of 0.8 mm between the center of two features 130. 0.8 mm corresponds to an object of an angular size of 0.9 arcmin, i.e. of less than 1 arcmin, located at an observation distance of 3 meters. The further below 0.8 mm the pitch gets, the smaller the angular size of a feature 130. Below an angular size of 1 arcmin, the eye can no longer see the features 130. In the nonlimiting example of FIGS. 6 and 7, it is the pitch p1 that is adjusted. Thus, in a nonlimiting example embodiment, the pitch p1 is smaller in the upper portion 13a of the textured film 13, in order to obtain features 130 that are closer to one another so as to make the top portion 13a of the textured film 13 more occulting, than in the bottom portion 13b where the pitch p1 is larger, so as to make the bottom portion 13b less occulting. The same principle may be applied to the punctiform features 132 of the case of FIG. 18. If the pitch p1′ is larger, then the punctiform features 132 are more spaced out, this further decreasing the transmission of the light Lx. The pitch p1′ is thus larger in the top portion 13a of the textured film 13, in order to obtain punctiform features 132 that are further apart from one another so as to make the top portion 13a of the textured film 13 more occulting, than in the bottom portion 13b where the pitch p1′ is smaller, so as to make the bottom portion 13b less occulting.

In one nonlimiting embodiment, the surface features 130 are produced using an IML process (IML standing for in-mold labeling) or an IMD process (IMD standing for in-mold decorating). In these methods, an ink is deposited on a film in order to produce the features 130 and thus add the texture to said film. In one nonlimiting embodiment, the ink deposit is between 1 and 10 microns thick.

In a second nonlimiting embodiment illustrated in FIGS. 9 to 11, the features 130 are bulk features. They lie in the thickness of the textured film 130. In this case, the features 130 have a depth to and a pitch p1 therebetween. In one nonlimiting embodiment, the depth t0 is between 0.03 mm and 0.15 mm. In one nonlimiting embodiment, the pitch p1 between the bulk features 130 is smaller than or equal to 0.04 mm. In this case, the bulk features 130 are not visible to an outside observer at any observation distance. In FIG. 10, the bulk features 130 are parallelepipedal in shape. It will be noted that the bulk features 130 may also be cylindrical in shape. In this case, to see what they would look like seen from the front, reference may be made to FIG. 8.

FIG. 12 illustrates a graph of the transmission of the light Lx in % as a function of the angle of incidence α in degrees of the light Lx originating from outside the vehicle 2 and incident on the surface 110, 140 of the device 1. The light Lx possesses an angle of incidence α that may be decomposed into a horizontal angle of incidence αₕ illustrated in FIG. 10 and into a vertical angle of incidence αᵥ illustrated in FIG. 9. The curve CH indicates the percentage transmission of the light Lx of horizontal angle of incidence αₕ, and the curve CV indicates the percentage transmission of the light Lx of vertical angle of incidence αᵥ. From the curve CV, it may be seen that the more the vertical angle of incidence αᵥ increases, the more the transmission of the light Lx is cut off. Whereas from the curve CH, it may be seen that as the horizontal angle of incidence αₕ increases, the transmission of the light Lx is not greatly attenuated. The small attenuation that may be seen is simply due to vitreous reflections from the surface 110, 140.

The part Lx″ of the light Lx that will not be transmitted through the surface 110, 140 has a vertical angle of incidence αᵥ of 40° or more. Thus, the features 130 cut off the light Lx beyond this angle of incidence α of 40°. Beyond this angle of incidence of 40°, the light Lx originating from outside is no longer able to enter into the device 1.

In a first nonlimiting variant embodiment illustrated in FIGS. 9 and 10, the features 130 transmit the light Lx constantly (in contrast to variable transmission) considering the surface 110, 140 in its entirety. In this case, the pitch p1 between the features 130 remains constant.

In a second nonlimiting variant embodiment illustrated in FIG. 11, the features 130 transmit the light Lx variably. The top portion 13a of the textured film 13 will be more occulting than the bottom portion 13b.

To make the transmission variable, the pitch p1 between the features 130 and/or the thickness of the features t1 130 are adjusted. In the nonlimiting example of FIG. 11, it is the pitch p1 that is adjusted. The pitch p1 is smaller in the top portion 13a of the textured film 13, in order to obtain features 130 that are closer to one another than in the bottom portion 13b where the pitch p1 is larger.

In FIG. 13, when the surface 110, 140 is observed from outside the vehicle and along the vehicle axis Ax, the height h1 of the features 130 may be seen but not their depth to. If the light Lx strikes said surface 110, 140 (comprising the textured film 13 with the bulk features 130) with a vertical angle of incidence αᵥ of 0°, then there is 55% transmission as indicated in the graph of FIG. 12; part of the light Lx is occulted by the features 130.

In FIG. 14, when the surface 110, 140 is observed from outside the vehicle at 20° with respect to the vehicle axis Ax, the height h1 of the features 130 and part of the depth t0 of the features 130 may be seen, these together being referenced h2 in FIG. 14. If the light Lx strikes said surface 110, 140 (comprising the textured film 13 with the bulk features 130) with a vertical angle of incidence αᵥ of 20°, then there is 30% transmission as indicated in the graph of FIG. 12; a large part of the light Lx is occulted by the features 130.

In FIG. 15, when the surface 110, 140 is observed from outside the vehicle and along the vehicle axis Ax, at a vertical angle of incidence αᵥ larger than or equal to 40°, the space between the features 130 is no longer seen. If the light Lx strikes said surface 110, 140 (comprising the textured film 13 with the bulk features 130) with a vertical angle of incidence αᵥ larger than or equal to 40°, then there is near to 0% transmission as indicated in the graph of FIG. 12; the light Lx is completely occulted by the features 130.

Thus it may be seen that, in all the embodiments presented above, transmission from outside the motor vehicle 2 to inside the device 1 of the ambient light Lx originating from outside the motor vehicle 2 is greatly reduced by virtue of the features 130.

This means that an observer O, represented by an eye in FIG. 16, owing to the ambient illumination, which is referred to as ambient light Lx originating from outside the motor vehicle 2, is unable to see the camera 10, the mask 15 or any other element of the device 1 located behind the exit outer lens 11.

Without the features 130, when the observer O is close to the device 1, the observer O is able to see the elements inside the device 1, and in particular the observer will be able to distinguish between the camera 10 and the mask 15. This is notably the case when the camera 10 is placed behind an illuminated logo and the light sources of the illuminated logo are turned off. “Close” means that the observer O is located between 1 meter and 3 meters from the motor vehicle 2 and therefore from the device 1, this typically corresponding to an observation angle α of between 20° and 48°. It will be noted that the observation angle α is the angle between the horizontal straight line passing through the middle of the surface 110, 140 and the straight line passing through the eye of the observer O. In contrast, by virtue of the features 130, the surface 110, 140 incorporating the features 130 is partly occulting when the observer O is close to the device 1. The observer will no longer be able to see elements inside the device 1. As illustrated in FIG. 16, the observer O, who is located at the position P1 at a distance D1 from the device 1 and at an observation angle α1, is close to the device 1.

The set of Barten curves in FIG. 17 illustrates curves of contrast sensitivity CSF. Five curves CSF1 to CSF5 illustrating contrast sensitivities of the eye have been plotted in the graph, for five different light levels representing various luminances of adaptation of the eye, the five curves CSF1 to CSF5 having a ratio of 10 between one and the next. The curves CSF1 to CSF5 thus relate to respective sensitivity-threshold values S of 0.1, 1, 10, 100 and 1000 candela per m² luminance of adaptation. The sensitivity threshold S is also referred to as the contrast sensitivity S. The spatial frequency u in cycles per degree (cpd) is plotted on the x-axis, and the sensitivity threshold S, i.e. the inverse of the value of the lowest contrast detectable at the spatial frequency u in question, is plotted on the y-axis. The spatial frequency u corresponds to the angular size of the object observed by the eye. Thus, in one nonlimiting example, if the camera 10 is 10 mm in size, the angular size corresponds to a spatial frequency u of 1.7 cpd at a distance of 1 m. At 10 meters, the angular size corresponds to 17 cpd, and at 25 m, it corresponds to 43 cpd.

The smaller the distance to the motor vehicle 2 and therefore to the device 1, the smaller the spatial frequency u becomes. Thus, in one nonlimiting example, the spatial frequency u will be between 5 cpd and 1.7 cpd for an object with a size of 10 mm. This corresponds to an observation angle α of between 20° and 48°. Approaching the device 1 is represented by a movement from right to left in the set of Barten curves. Thus, the smaller the spatial frequency u, the better the elements inside the device 1 may be seen, i.e. the greater the contrast sensitivity S between the surface 110, 140 incorporating the features 130 and the elements inside the device 1. In this case, the contrast sensitivity S of the eye increases.

Thus, the closer the observer O is to the motor vehicle 2 and therefore to the device 1, the more the contrast sensitivity S of the eye increases. The observer will therefore be able to better see the elements inside the device 1 if there are no features 130 on the surface 110, 140. The observer's perception of the contrast between the elements inside the device 1 will be good, this contrast representing a difference in luminance that may be expressed by (Lmax−Lmin)/(Lmax+Lmin), where Lmax is the luminance of the camera 10 and Lmin is the luminance of the mask 15 in one nonlimiting embodiment.

To ensure that the observer O when close to the device 1 is unable to see the elements inside the device 1, it is possible to adjust luminance level locally by decreasing local ambient light Lx on the surface 110, 140 of the device 1. There will thus be a change from a curve CSF with a higher brightness level to a curve CSF with a lower brightness level. There will thus be a movement from right to left in the set of curves. Lowering ambient light Lx reduces the luminance level. Contrast sensitivity S is thus decreased. Thus, with the set of curves of FIG. 17, for a given spatial frequency u, for example 10 cpd, it may be seen that contrast sensitivity S decreases as the amount of local ambient light Lx decreases, i.e. the contrast between the elements inside the device 1 (between the camera 10 and the mask 15 in particular) through the surface 110, 140 will be less perceptible to the eye, even though said contrast may be the same.

The decrease in the amount of local ambient light Lx is achieved by means of features 130 located on the surface 110, 140 according to the various embodiments described above. The surface 110, 140 which, by virtue of the features 130, is thus partially or completely occulting, will thus limit or decrease to zero the amount of ambient light Lx that enters the device 1.

In contrast, the larger the distance to the motor vehicle 2 and therefore to the device 1, the more the spatial frequency u tends to increase beyond 10 cpd to as much as 60 cpd. This corresponds to an observation angle α that approaches 0°. As illustrated in FIG. 16, the observer O, who is located at the position P2 at a distance D2 greater than the distance D1 and at an observation angle α2 less than the observation angle α1, is far from the device 1. It should be noted that the observer at the position P2 may be at the same height as the observer at the position P1, but their distance D2 is much greater than the distance D1.

Moving away is represented by a movement to the right in the set of Barten curves. On the right, the contrast sensitivity S of the eye decreases greatly. Thus, the higher the spatial frequency u, the more difficult it will be to see elements inside the device 1, i.e. the less the contrast between the elements inside the device 1 (between the camera 10 and the mask 15 in particular) will be perceptible to the eye.

In position P2, the observer O will be less able to see the elements inside the device 1. Specifically, when the observer O is far from the device 1, the elements inside the device 1 will be smaller in angular size, this corresponding to a higher spatial frequency u, and therefore to a lower contrast sensitivity S. It will be noted that the set of Barten curves is valid for day or night vision.

In a third nonlimiting embodiment shown in FIG. 19, the masking zone 13 is a cold mirror. In one nonlimiting variant embodiment, the masking zone 13 comprises:
a substrate 134, and
a plurality of layers 135 having alternating high and low refractive indices, denoted respectively nh and nl.

The substrate 134 is positioned facing the camera 10. In one nonlimiting example, the substrate 134 is made of polycarbonate having a refractive index of 1.591.

Thus, two adjacent layers 135 have different refractive indices, specifically a high refractive index nh and a low refractive index nl. In one nonlimiting example, the layer or layers 135 having a low refractive index nl are magnesium fluoride layers. In one nonlimiting example, nl=1.37. In one nonlimiting example, the layer or layers 135 having a high refractive index nh are titanium dioxide layers. In one nonlimiting example, nh=2.61

In the nonlimiting example shown in FIG. 19, the masking zone 13 comprises four layers 135 including a layer 135 having a low refractive index nl adjacent to the substrate 134, followed by a layer 135 having a high refractive index nh, followed by a layer 135 having a refractive index nl, followed by a final layer 135 having a high refractive index nh.

The substrate 134 and the set of layers 135 thus provide a reflective treatment that enables up to 50% of the light LX striking the device 1 to be reflected. Thus, a part Lx′ of the light Lx is transmitted through the device 1 and the rest Lx″ of the light Lx is reflected. This provides a reflective effect preventing an observer O from seeing the elements inside the device 1, including the camera 10, while enabling the camera 10 to operate correctly. The observation function S is therefore not degraded. Consequently, regardless of the type of camera 10 (an IR camera, an NIR camera or a camera operating in the visible spectrum), said camera will be able to correctly detect objects in the environment outside the motor vehicle 2.

In a fourth nonlimiting embodiment shown in FIG. 20, the masking zone 13 comprises:
a substrate 134, and
a single metal layer 135 having a thickness e1 in the order of nanometers.

The substrate 134 is positioned facing the camera 10.

In nonlimiting examples, the metal layer 135 is a layer of chromium, aluminum, germanium, or silicon. In a nonlimiting example, the thickness e1 is 30 nanometers for a metal layer 135 made of aluminum. This provides a semi-reflective layer. Thus, a portion Lx′ of the light Lx is transmitted through the device 1 and the rest Lx″ of the light Lx is reflected. This provides a reflective effect preventing an observer O from seeing the elements inside the device 1, including the camera 10, while enabling the camera 10 to operate correctly. The observation function S is therefore not degraded.

Of course, the description of the invention is not limited to the embodiments described above and to the field described above. Thus, in another nonlimiting embodiment, when the features 130 are punctiform features, their cross section may be hexagonal in shape, triangular in shape, rectangular in shape, etc. Thus, in one nonlimiting embodiment, the device 1 comprises a plurality of cameras 10.

Thus, the invention described notably has the following advantages:
it helps to reduce the transmittance of the surface 110, 140 of the device 1,
it conceals the elements inside the device 1 (notably the camera 10 and the mask 15) under close observation, without affecting the performance of said camera 10 of the device 1 used to carry out the observation function F,
it is an alternative solution that is less bulky than a mechanical solution using a movable mask,
it is an alternative solution that is cheaper than an electro-optical solution using an LCD screen to occult the light Lx,
it is a solution that works with all types of cameras 10 (IR, NIR, in the visible spectrum), unlike a solution using an interference filter reflecting 100% of the light Lx coming from outside the device 1.

1. A device for a vehicle, said device being configured to perform an observation function and comprising a camera, an exit outer lens and a subassembly comprising said camera, wherein said device comprises a masking zone covering a surface of said device, said masking zone being positioned facing said camera and configured to reduce the transmission of light entering said device through said surface.

2. The device as claimed in claim 1, wherein said surface is covered in whole or in part by said masking zone.

3. The device as claimed in claim 1, wherein said surface belongs to said exit outer lens.

4. The device as claimed in claim 3, wherein said exit outer lens belongs to a style part of said device.

5. The device as claimed in claim 1, wherein said surface belongs to an intermediate element of said device positioned between said camera and said exit outer lens.

6. The device as claimed in claim 1, wherein said masking zone is a textured film comprising features.

7. The device as claimed in claim 1, wherein said features are surface features or bulk features.

8. The device as claimed in claim 7, wherein said surface features are produced using an IML or IMD process.

9. The device as claimed in claim 7, wherein when said features are surface features, they are formed by an ink deposit between 1 and 10 microns thick.

10. The device as claimed in claim 6, wherein said features are occulting or semi-transparent.

11. The device as claimed in claim 6, wherein said features are continuous lines or punctiform features.

12. The device as claimed in claim 6, wherein there is a pitch between said features and said pitch has a maximum value of 0.8 mm between the center of two features.

13. The device as claimed in claim 6, wherein said surface comprising said textured film is configured to transmit light variably.

14. The device as claimed in claim 13, wherein said features are arranged so that there is a variable pitch between said features and/or so that the features have a variable material density and/or so that the features have a variable area.

15. The device as claimed in claim 6, wherein said features form a negative image of punctiform features, said punctiform features being substantially transparent.

16. The device of claim 15, wherein said surface comprising said textured film is configured to transmit light variably.

17. The device as claimed in claim 16, wherein said punctiform features are arranged so that there is a variable pitch between said punctiform features and/or so that the punctiform features have a variable area.

18. The device as claimed in claim 16, wherein the negative image comprises different areas (sf) with different material densities.

19. The device as claimed in claim 1, wherein said masking zone is a cold mirror.

20. The device as claimed in claim 19, wherein said masking zone comprises a plurality of layers with alternating high and low refractive indices.

21. The device as claimed in claim 1, said masking zone comprises a single metal layer having a thickness in the order of nanometers.
